(19) United States
(12) Patent Application Publication
(10) Pub. No.: US 2004/0257453 A1
(43) Pub. Date: Dec. 23, 2004

(54) Apparatus for and method of interfacing between an image sensor and an image processor

(75) Inventors: Yeon-Cheol Lee, Kyunggi-Do (KR); Boo-Dong Kwak, Kyunggi-Do (KR); Sang-Hyun Park, Kyunggi-Do (KR); Hyung-Man Park, Seoul (KR); Jong-Sik Jeong, Seoul (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/619,835

(22) Filed: Jul. 16, 2003

(30) Foreign Application Priority Data
Jun. 23, 2003 (KR) 2003-40753

(51) Int. Cl. H04N 5/335

(52) U.S. Cl. 348/222.1

(57) ABSTRACT

An interface apparatus of an image processing system includes an image sensor sensing an image, an image processor processing the sensed image to output image data, and a sensor interface coupled between the image sensor and the image processor. The sensor interface includes a sensor type register storing information about the image sensor, a micom storing the information in the sensor type register to control the image sensor, and a sensor signal processor receiving signals corresponding to the sensed image from the image sensor, converting the signals into modified signals, which the image processor processes to output the image data, according to the information stored in the sensor type register, and transmitting the modified signals to the image processor. The interface apparatus used in the image processing system, such as a digital camera, adaptively correspond to the image sensor which is currently used in the image processing system and has one of different types of image sensors, according to the manufacturers and product models of the image sensors. The interface apparatus adaptively processes signals outputted from the image sensor, thereby avoiding any additional redesigning process of redesigning the image processor to correspond to the image sensor used in the image processing system, and reducing a manufacturing time and cost of the image processing system.

### CROSS-REFERENCE TO RELATED APPLICATION

This application claims to benefit of Korean Patent Application No. Year-Number, filed Month day, Year, in the Korean Intellectual Property Office, the disclosure of which is incorporated herein by reference.

### BACKGROUND OF THE INVENTION

1. Field of the Invention

The present invention relates to an interface apparatus coupled between an image processor and an image sensor and an interface method thereof, and more particularly, to an interface apparatus for and an interface method of converting an output signal of an image sensor into image processing data to be processed by an image processor using the output signal outputted from the image sensor without changing a design of the image processor according to the output signal of the image sensor in an image processing system, such as a digital camera, thereby reducing a time consumption and a high cost required to redesign the image processor in different ways according to output signals outputted from image sensors which are different from each other according to manufacturers and product models of the image sensors.

2. Description of the Related Art

Generally, an apparatus or system including an image processing system, such as a digital camera, obtains analog image data from an image sensed by an image sensor through a lens, converts the analog image data into digital data, and generates synchronization signals according to each frame so as to transmit the digital data to the image processor. Based on the synchronization signals, the image processing unit receives pixel data from the image sensor, converts the pixel data into format data using image compression coding, i.e., JPEG or MPEG coding, to generate a coded image data, and transmits the coded image data, which is coded through the image compression coding, to a memory or display apparatus of the digital camera through a host interface.

The image sensor used in the apparatus or system including the image processing unit is one of a charged coupled device (CCD) image sensor and a complementary metal oxide semiconductor (CMOS) image sensor which convert an optical signal into an electrical signal.

The CCD image sensor includes a plurality of optical diodes coupled to a plurality of subminiature metal electrodes arranged on a silicon wafer to convert optical energy into electrical energy when the optical diodes receives light. The photo diodes disposed to correspond to the respective image pixels generate charge to be transmitted to an amplifier through a vertical transmission CCD and a horizontal transmission CCD using a high potential difference. Although a power consumption increases in the apparatus or the system using the CCD image sensor, a signal generated from the image sensor has a high signal to noise (SN) ratio, and the apparatus or system has a characteristic that the signal is uniformly amplified.

The CMOS image sensor includes a photo diode and an amplifier which are disposed on each image pixel. Although the power consumption of the CMOS image sensor is less than that of the CCD image sensor and is smaller than the CCD image sensor in size, a picture quality deteriorates.

Since there are various kinds of the CCD image sensor and the CMOS image sensor, an interface and a characteristic of an image processor become different from other image processors according to the kinds of the image sensors and manufacturers of the image sensors. Accordingly, the image processor should be designed and manufactured according to a specific image sensor and is required to be re-designed according to another specific image sensor, which replaces the specific image sensor when the specific image sensor is not available due to a shortage of the specific image sensor, so as to process data outputted from the another specific image sensor and having a different characteristic from that of the specific image sensor.

Japanese patent publication No. 2003-46878 discloses a timing generating apparatus generating various types of timing signals used in corresponding ones of the pixel data of the CCD image sensors according to the CCD image sensors. According to the above patent publication, the timing signals are generated to correspond to respective CCD image sensors, which generate different kinds of the timing signals, to process the pixel data according to the timing signals. However, there are the timing signals as well as other data and synchronization signals to be processed, and most of the timing signals, the other data, and the synchronization signals are different from each other according to manufacturers and product models of the image sensors. The timing generating apparatus shown in the above patent publication has a limitation in corresponding to various kinds of the image sensors. Moreover, an image processing system using the timing generating apparatus is required to be redesigned according to the image sensor used in the image processing system.

FIG. 1 is a structure of a conventional image signal processing system of a digital camera. As shown in FIG. 1, an image sensed by an image sensor 11 through a lens 10 is converted into an image signal using an A/D converter disposed in the image sensor 11, and the image signal is transmitted to an image processor 12. If the image sensor 11 does not include the image processor 12, the image signal is transmitted to the image processor 12 from the image sensor 11 as a Bayer color filter array pattern.

The image processor 12 processes the image signal using color filter array interpolation, color matrix conversion, color correction, and color enhancement functions. Signals used as synchronization signals of each image frame include a vertical synchronization signal vsync representing a start point of the image frame, a horizontal synchronization signal hsync representing an active state of each line image of the image frame, and a pixel clock signal pixel_clock representing synchrozation of pixel data. The image signal is transmitted to the image processor as the pixel data pixel_data corresponding to the image.

Image data processed in the imager processor 12 is converted into format data of CCIR 656 or CCIR 601 format (YUV space) data, and the format data is transmitted to an image coding (MPEG or JPEG coding) unit 13 as a YUV 4:2:2 type signal or a YUV 4:2:0 type signal to be processed in an image coding process.

The coded image data (coded frame data) is stored in a frame buffer 14 and transmitted to a storage apparatus, such as the digital camera or a personal computer, or a display apparatus through a host interface 15, such as the digital camera or the personal computer.

In most image sensors, an image sensor output signal includes the vertical synchronization signal vsync, the horizontal synchronization signal hsync, the pixel clock signal pixel_clock, and bidirectional input and output signals controlling the image sensor 11. These signals are used to interface between the image sensor 11 and the image processor 12 in the apparatus or system, such as the digital camera.

FIG. 7 is a view showing data specification processed by the image sensor according to manufacturers and product models. Referring to FIG. 7, standards of the processed data are different from each other according to the manufacturers and the product models of the image sensor.

FIG. 2 is a block diagram showing a structure transmitting signals from the image sensor 11 to the image processor 12 in the conventional image signal processing system shown in FIG. 1. The signals including the vertical synchronization signal vsync, the horizontal synchronization signal hsync, the pixel clock signal pixel_clock, and the bidirectional input and output signals become different from each other according to the manufacturers and the product models of the image sensor 11.

If the image processor 12 is included in an inside of the image sensor 11, an output of the image sensor 11 is the processed format data, such as the CCIR 656 or CCIR 601 format (YUV space) data. In this case, the image processor 12 is used as a converter converting the format data into input data inputted into the image coding unit 13. A plurality of internal registers disposed in the image sensor 11 are coupled to pixel sensors through two or three wires using a serial communication method so that the image data is written in or read from the internal registers of the image sensor 11. Since a characteristic of the image varies depending on a way in which the image data is written in the internal registers of the image sensor 11, determining of the image data written in the internal registers of the image sensor 11 is a very important factor to control the characteristic of the image.

As described above, differences between the vertical synchronization signals vsync, the horizontal synchronization signals hsync, and the pixel clock signals pixel_clock which are the synchronization signals of the image frame, a magnitude of a pixel array pixel_array, an existence of the image processor 12 in the image sensor 11, a number of different types of Bayer color filter array patterns, and differences between serial communication methods of controlling the image sensors 11 vary according to the manufacturers. Accordingly, the image processor 12 of the apparatus or system, such as the digital camera, is required to be redesigned according to the specific image sensor 11.

In a case that the image sensor 11 to be used in the above apparatus needs to be changed, the image processor 12 must be redesigned according to changes of the signals transmitted between the image sensor 11 and the image processor 12 although image processing algorithm is not substantially changed since the most image processing system is formed in a large scaled integrated circuit (LSI), it requires significant expanses and time in redesigning and producing the image processor 12.

### SUMMARY OF THE INVENTION

In order to solve the above and/or other problems, it is an aspect of the present invention to provide an interface apparatus and method of interfacing between an image sensor and an image processor in an image processing system having the image sensor and the image processor to adaptively correspond to respective image sensors having different types according to manufacturers and product models of the image sensors.

It is an aspect of the present invention to provide interface apparatus and method of interfacing between an image sensor and an image processor in an image processing system to be used in any one of different types of image sensors without redesigning the image processor corresponding to the image sensor so as to reduce manufacturing time and expenses of the image processing system, such as a digital camera.

Additional aspects and advantages of the invention will be set forth in part in the description which follows and, in part, will be obvious from the description, or may be learned by practice of the invention.

To achieve the above and/or other aspects of the present invention, interfacing apparatus and method can be used in different types of image sensors, which are different from each other according to manufacturers of the image sensors to correspond to the image sensors in an image processing system.

The interface apparatus disposed between the image sensor and the image processor in the image processing system includes an image sensor sensing an image, an image processor processing the sensed image to output image data, and a sensor interface coupled between the image sensor and the image processor. The sensor interface includes a sensor type register storing information about the image sensor, a micom storing the information in the sensor type register to control the image sensor, and a sensor signal processor receiving signals corresponding to the sensed image from the image sensor, converting the signals into modified signals, which the image processor processes to output the image data, according to the information stored in the sensor type register, and transmitting the modified signals to the image processor.

According to another aspect of the present invention, the signals include a vertical synchronization signal, a horizontal synchronization signal, a pixel clock signal, and pixel data.

According to another aspect of the present invention, the information stored in the sensor type register includes polarity information of the vertical synchronization signal, the horizontal synchronization signal, and the pixel clock signal, image signal processing (ISP) mode information and pattern signal information of the image processor, horizontal size information of the sensed image, and vertical size information of the sensed image.

According to another aspect of the present invention, the sensor type register includes a sensor signal register, a horizontal size register, and a vertical size register.

According to another aspect of the present invention, the sensor signal register stores the polarity information and the image signal processing (ISP) mode information, the horizontal size register stores the horizontal size information, and the vertical size register storing the vertical size information.

According to another aspect of the present invention, the sensor signal processor includes a first multiplexer inverting or non-inverting a polarity of the vertical synchronization signal transmitted from the image sensor according to the polarity information of the vertical synchronization signal stored in the sensor type register, a second multiplexer outputting an output of the first multiplexer or a low state signal to the image processor according to the image signal processing (ISP) mode information of the image processor, a third multiplexer inverting or non-inverting a polarity of the horizontal synchronization signal transmitted from the image sensor according to the polarity information of the horizontal synchronization signal stored in the sensor type register, a fourth multiplexer outputting an output of the third multiplexer or the low state signal to the image processor according to the image signal processing (ISP) mode information of the image processor, a fifth multiplexer inverting or non-inverting a polarity of the pixel clock signal transmitted from the image sensor according to the polarity information of the pixel clock signal stored in the sensor type register, a sixth multiplexer outputting an output of the fifth multiplexer or the low state signal to the image processor according to the image signal processing (ISP) mode information of the image processor, and a seventh multiplexer outputting the pixel data signal or the low state signal to the image processor according to the image signal processing (ISP) mode information of the image processor.

According to another aspect of the present invention, the micom communicates with the image sensor using a general purpose input/ouput signal transmitted between the micom and the image sensor.

To achieve the above and/or other aspects of the present invention, an interface method of interfacing an image sensor and an image processor in an image processing system includes storing information about the image sensor in a sensor type register, receiving signals from the image sensor, converting the signals outputted from the image sensor into image data according to the information stored in the sensor type register, and transmitting the converted image data to the image processor.

According to another aspect of the present invention, the signals include a vertical synchronization signal, a horizontal synchronization signal, a pixel clock signal, and pixel data.

According to another aspect of the present invention, the information stored in the sensor type register includes polarity information of the vertical synchronization signal, the horizontal synchronization signal, and the pixel clock signal, image signal processing (ISP) mode information and pattern signal information of the image processor, horizontal size information of the sensed image, and vertical size information of the sensed image.

According to another aspect of the present invention, the sensor type register includes a sensor signal register, a horizontal size register, and a vertical size register.

According to another aspect of the present invention, the storing of the information about the image sensor in the sensor type register includes storing the polarity information and the image signal processing (ISP) mode information in the sensor signal register, storing the horizontal size information in the horizontal size register, and storing the vertical size information in the vertical size register.

According to another aspect of the present invention, the converting of the signals outputted from the image sensor into the image data according to the information stored in the sensor type register includes inverting or non-inverting a polarity of the vertical synchronization signal transmitted from the image sensor according to the polarity information of the vertical synchronization signal stored in the sensor type register, outputting the inverted or non-inverted vertical synchronization signal or a low state signal to the image processor according to the image signal processing (ISP) mode information of the image processor, inverting or non-inverting a polarity of the horizontal synchronization signal transmitted from the image sensor according to the polarity information of the horizontal synchronization signal stored in the sensor type register, outputting the inverted or non-inverted horizontal synchronization signal or the low state signal to the image processor according to the image signal processing (ISP) mode information of the image processor, inverting or non-inverting a polarity of the pixel clock signal transmitted from the image sensor according to the polarity information of the pixel clock signal stored in the sensor type register, outputting the inverted or non-inverted pixel clock signal or the low state signal to the image processor according to the image signal processing (ISP) mode information of the image processor, and outputting the pixel data signal or the low state signal to the image processor according to the image signal processing (ISP) mode information of the image processor.

### BRIEF DESCRIPTION OF THE DRAWINGS

These and other advantages of the invention will become apparent and more readily appreciated from the following description of the preferred embodiments, taken in conjunction with the accompanying drawings of which:

FIG. 1 is a structure of a conventional image signal processing system;

FIG. 2 is a block diagram showing a structure transmitting signals from an image sensor to an image processor in the conventional image signal processing system shown in FIG. 1;

FIG. 3 is a sensor interface coupled between an image sensor and an image processor in an image signal processing system according to an embodiment of the present invention;

FIGS. 4A, 4B, and 4C are structures of sensor type registers of the image signal processing system shown in FIG. 3;

FIG. 5 is an internal structure of the sensor interface shown in FIG. 3;

FIG. 6 is a structure of the image processor shown in FIG. 3; and

FIG. 7 is a view showing data specification processed by the image sensor according to manufacturers and product models.

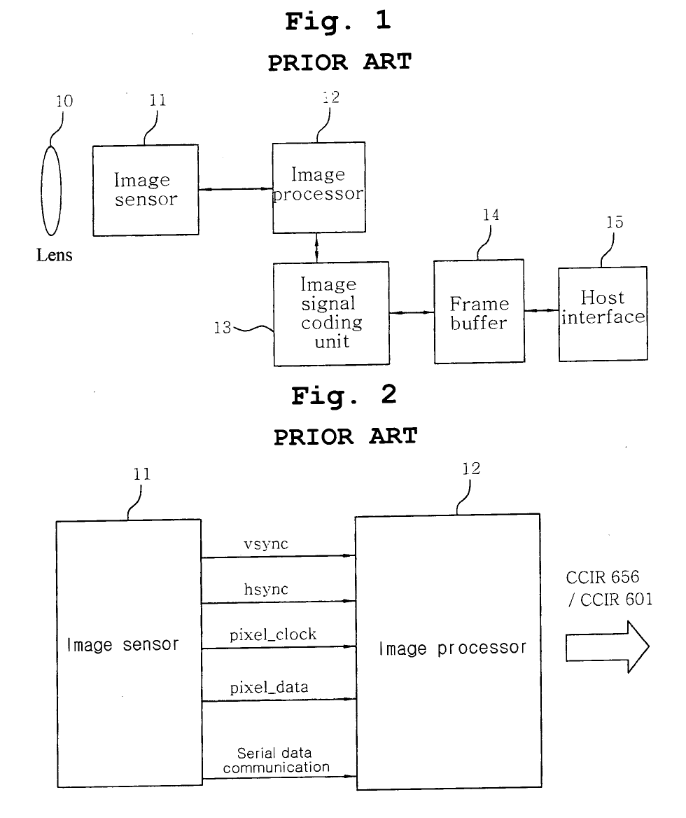

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by reference to the figures.

FIG. 3 shows a sensor interface 302 coupled between an image sensor 301 and an image processor 303 in an image signal processing system according to an embodiment of the present invention.

Referring to FIG. 3, the sensor interface 302 is disposed between the image sensor 301 and the image processor 303. The sensor interface includes a sensor signal processor 304, a sensor type resister 305, and a micro computer (micom) 306.

The image processor 303 includes a micro processor performing a function of processing a signal, and the micro processor of the image processor 303 may perform functions of the micom 306. Although FIG. 3 shows the micom 306 is separated from the image processor 303, the micro processor of the image processor 303 may perform the functions of the micom of the image interface 302 through a program stored in a specific processor or a memory included in the image processor 303 without providing the specific processor and the memory performing the function of the micom 306 to the sensor interface 302.

An image is sensed by the image sensor 301 through a lens (not shown) so as to generate analog image data. The analog image data is converted into digital data by an analog to digital (A/D) converter, and a synchronization signal corresponding to each frame is generated to be transmitted to the image processor 303. The image processor 303 receives the digital data from the image sensor 301 based on the synchronization signal and converts the digital data into format data (image data) to be processed in a coding processing unit (not shown) using an image coding process. Signals outputted from the image sensor 301 include a vertical synchronization signal vsync representing a start point of an image frame, a horizontal synchronization signal hsync representing an active state of each line image of the image frame, a pixel data (digital data) signal pixel_data representing data outputted from each image pixel, and a pixel clock signal pixel_clk representing synchrozation of the pixel data signal pixel-data.

The signals including the vertical synchronization signal vsync, the horizontal synchronization signal hsync, and the pixel clock signal pixel_clk, which are outputted from the image sensor 301, are synchronized with the synchronization signal, and these signals includes information representing that each frame is one of low and high signals or rising and falling edges for synchronization of each frame. The pixel data signal pixel_data includes data transmitted from respective image pixels.

The vertical synchronization signal vsync, the horizontal synchronization signal hsync, and the pixel clock signal pixel_clk are inputted into the sensor signal processor 304 of the sensor interface 302 from the image sensor 301 before being inputted into the image processor 303.

The micom 306 includes a processor and readable/writable memory, e.g, a RAM, and the readable/writable memory stores information about the image sensor 301 and a program controlling the image sensor 301 which is used in the image signal processing system. According to the image sensor 301 used in the image signal processing system, the information is changed to represent the image sensor 301 which is mounted in the image signal processing system, and the program is also changed to control the image sensor 301 which is mounted in the image signal processing system. An internal operation of each image pixel of the image sensor 301 is controlled by a general purpose input/output (GPIO) signal which is controlled by the micom 306. The GPIO signal includes two or three line signals and includes a synchronization clock signal and a data signal to perform a write/read operation. These signals are bidirectional signals which is controllable by the micom 306, so as to adaptively correspond to one of different image sensors having different characteristics.

The micom 306 writes (stores) the information about the image sensor 301 in the sensor type register 305. According to the information stored in the sensor type register 205, the sensor signal processor 304 changes the vertical synchronization signal vsync, the horizontal synchronization signal hsync, the pixel clock signal pixel_clk, and the pixel data signal pixel data which are compatible with the image sensor 301 which is mounted in the image signal processing system. As shown in FIG. 3, the changed vertical synchronization signal vsync_1, the changed horizontal synchronization signal hsync_1, and the changed pixel clock signal pixel_clk_1, and the changed pixel data signal pixel_data_1 are inputted to the image processor.

A pattern signal “pattern” informs the image processor 303 of one of types of patterns outputted from the image sensor 301. In a case that the image sensor 301 does not include a specific image processor, the pattern signal “pattern” represents that the signals transmitted from the sensor type register 305 to the image processor 303 is a Bayer pattern. The Bayer pattern includes the following patterns.

00: rgrgrg . . .

gbgbgbg . . .

01: bgbgbg . . .

grgrgr . . .

10: gbgbg . . .

rgrgrg . . .

11: grgrgr . . .

bgbgbg . . .

In another case that the image sensor 301 includes the specific image processor, the pattern signal “pattern” represents that the signals transmitted from the sensor type register 305 to the image processor 303 is a YUV pattern. The pattern signal “pattern” includes the information about the YUV pattern.

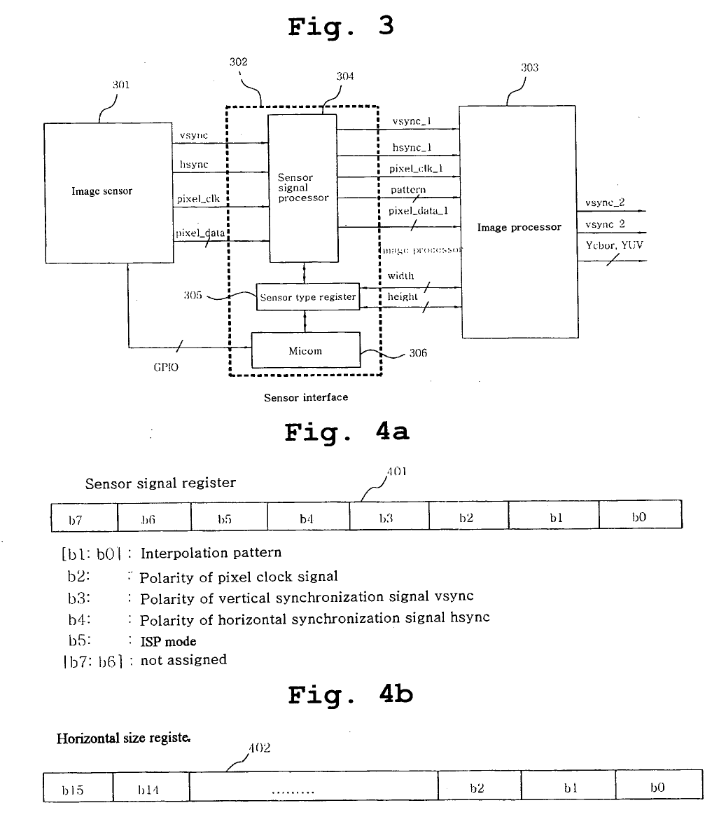

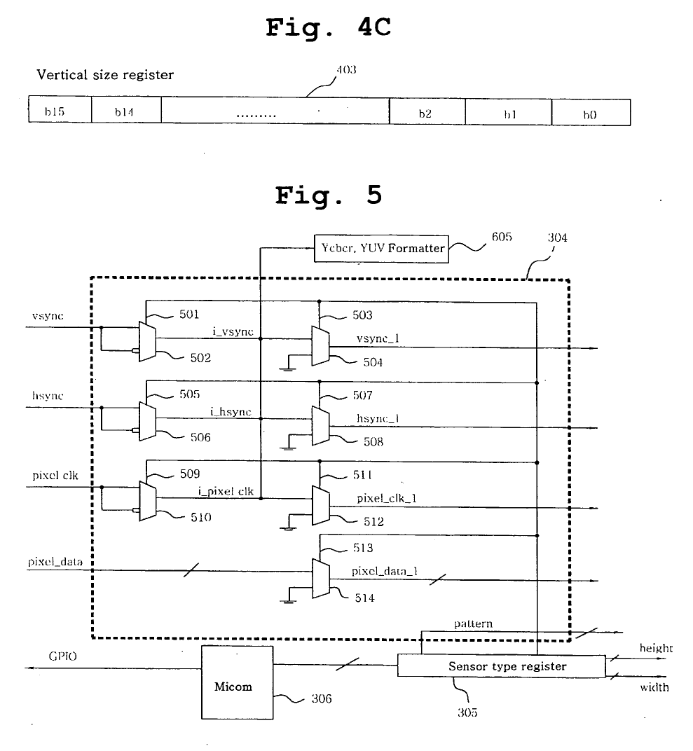

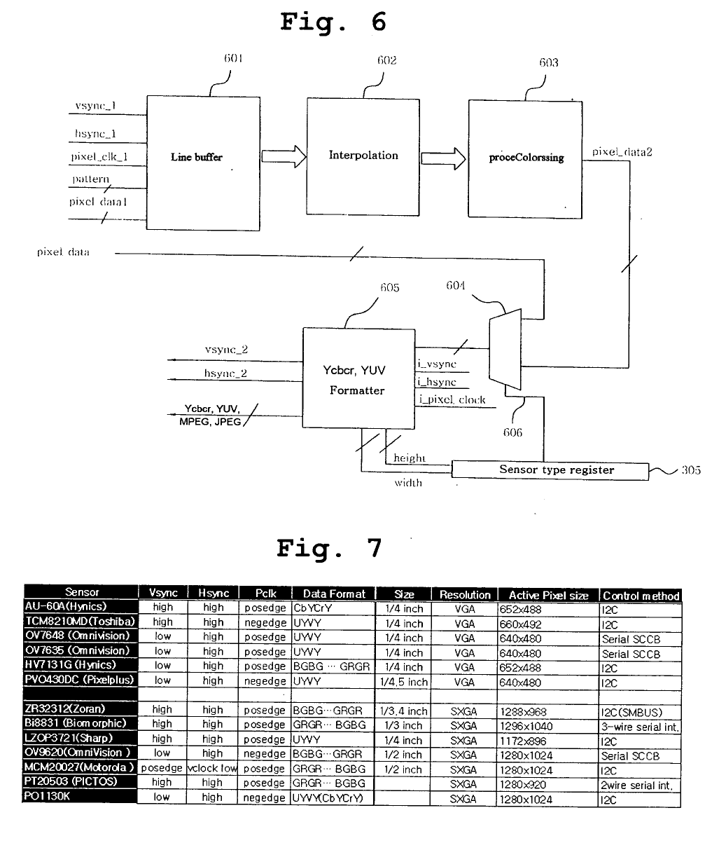

The sensor type register 305 stores the information about the pattern signal “pattern” in blocks [b1:b0] shown in FIG. 4A. The micom 306 transmits the information stored in the sensor type register 305 as the pattern signal “pattern” to the image processor 303. The information about an image size stored in the sensor type register 305 is transmitted from the sensor type register 305 to the image processor 303. The information about the image size includes a horizontal size signal “width” representing horizontal size information of the image, and a vertical size signal “height” representing vertical size information of the image.

The image processor 303 generates another vertical synchronization signal vsync_2, another horizontal synchronization signal hsync_2, and luminance and chrominance signals Ycbor and YUV as inputs of the image signal coding unit for the image coding process by processing the changed vertical synchronization signal vsync_1, the changed horizontal synchronization signal hsync_1, and the changed pixel clock signal pixel_clk_1, and the changed pixel data signal pixel_data_1.

FIGS. 4A, 4B, and 4C are structures of a sensor signal register 401, a horizontal size register 402, and a vertical size register 403 of the sensor type register 305 of the image signal processing system shown in FIG. 3.

As shown in FIGS. 4A, 4B, and 4C, an interpolation pattern is stored in a block [b1:b0] of the sensor signal register 401, a polarity of the pixel clock pixel_clock is stored in a block b2 of the sensor signal register 401, a polarity of the vertical synchronization signal vsync is stored in a block b3 of the sensor signal register 401, a polarity of the horizontal synchronization signal hsync is stored in a block b4 of the sensor signal register 401, an image signal processing (ISP) mode (an operation mode of the image processor 303 or information representing whether the image processor 303 is in an on state or an off state) is stored in a block b5 of the sensor signal register 401. The horizontal size register 402 stores the horizontal size information “width” of the image, and the vertical size register 403 stores the vertical size information “height” of the image. Although FIGS. 4A, 4B, 4C show the above structures of the sensor signal register 401, the horizontal size register 402, and the vertical size register 403 of the sensor type register 305, the present invention is not limited thereto.

FIG. 5 is an internal structure of the sensor interface 302 shown in FIG. 3. Referring to FIG. 5, a signal converting process performed in the sensor interface 302 is described in detail hereinafter.

The vertical synchronization signal vsync representing the start point of the frame of the image is inverted or not inverted by a first multiplexer 502 using the polarity of the vertical synchronization signal vsync stored in the block b3 of the sensor signal register 401 of the sensor type register 305 as shown in FIG. 4A as a first control signal 501, thereby outputting a signal i_vsync which is one of an inverted (polarity-inverted) signal and a non-inverted (polarity-non-inverted) signal of the vertical synchronization signal vsync. For example, if the control signal 501 is a high signal, the vertical synchronization signal vsync is bypassed or not changed to the inverted signal, and if the control signal 501 is a low signal, the vertical synchronization signal vsync is changed to the inverted signal. The signal i_vsync is bypassed to be outputted as the changed vertical synchronization signal vsync_1 or becomes a low level state (is grounded) by a second multiplexer 502 using the ISP mode signal stored in the block b5 of the sensor signal register 401 of FIG. 4A as a control signal. That is, the signal i_vsync is bypassed to be transmitted to the image processor 303 when the ISP mode signal is in the on state, and the signal i_vsync becomes the low level state (grounded) when the ISP mode signal is in the off state.

The horizontal synchronization signal hsync representing an active state of each line of the image within the frame is inverted or not inverted to the inverted (polarity-inverted) signal or the non-inverted (polarity-non-inverted) signal by a third multiplexer 506 using the polarity of the horizontal synchronization signal hsync stored in the block b4 of the sensor signal register 401 of FIG. 4A as a second control signal 505, thereby outputting a singal i_hsync which is one of the inverted (polarity-inverted) signal or the non-inverted (polarity-non-inverted) signal of the horizontal synchronization signal hsync. For example, if the second control signal 505 is the high signal, the horizontal synchronization signal hsync is bypassed (transmitted) without being inverted, and if the second control signal 505 is the low signal, the horizontal synchronization signal hsync is inverted. The signal i_hsync is bypassed (not inverted) to be outputted as the changed horizontal synchronization signal hsync_1 or becomes a low level state (is grounded) by a fourth multiplexer 508 using the ISP mode control signal stored in the block b5 of the sensor signal register 401 as the control signal. That is, the signal i_hsync is bypassed to be transmitted to the image processor 303 when the ISP mode signal is in the on state, and the signal i_hsync becomes the low level state (grounded) when the ISP mode signal is in the off state.

The pixel clock signal pixel_clk representing the synchronization of the pixels data of the image pixels is inverted or not inverted to the inverted (polarity-inverted) signal or the non-inverted (polarity-non-inverted) signal by a fifth multiplexer 510 using the polarity of the pixel clock signal pixel_clk stored in the block b2 of the sensor signal register 401 of FIG. 4A as a third control signal 511, thereby outputting a signal i_pixel_clk which is one of the inverted (polarity-inverted) signal or the non-inverted (polarity-non-inverted) signal of the pixel clock signal pixel_clk. For example, if the third control signal 511 is the high signal, the pixel clock signal pixel_clk is bypassed (transmitted) without being inverted, and if the third control signal 505 is the low signal, the pixel clock signal pixel_clk is inverted. The signal i_pixel_clk is bypassed (not inverted) to be outputted as the changed pixel clock signal pixel_clk_1 or becomes a low level state (is grounded) by the sixth multiplexer 512 using the ISP mode control signal stored in the block b5 of the sensor signal register 401 as the third control signal. That is, the signal i_pixel_clk is bypassed to be transmitted to the image processor 303 when the ISP mode signal is in the on state, and the signal i_pixel_clk becomes the low level state (grounded) when the ISP mode signal is in the off state.

The pixel data signal pixel_data is inverted or not inverted to the inverted (polarity-inverted) signal or the non-inverted (polarity-non-inverted) signal by a seventh multiplexer 514 using the polarity of the pixel data signal pixel_data stored in the block b5 of the sensor signal register 401 of FIG. 4A as a fourth control signal 511, thereby outputting the changed pixel data signal pixel_data_1 which is one of the inverted (polarity-inverted) signal or the non-inverted (polarity-non-inverted) signal of the pixel data signal pixel_data. That is, the pixel data signal pixel_data is bypassed to be transmitted to the image processor 303 when the ISP mode signal is in the on state, and the pixel data signal pixel_data becomes the low level state (grounded) when the ISP mode signal is in the off state.

An interpolation value stored in the block [b0:b1] of the sensor signal register 401 of the sensor type register 305 shown in FIG. 4A is transmitted to the image processor 303 as the pattern signal “pattern.” The pattern signal “pattern” is the Bayer pattern of the image sensor 301 and becomes significant when the ISP mode signal stored in the sensor signal register 401 is in the on state.

The horizontal size signal “width” is a value stored in the block [b15:b0] of the horizontal magnitude register 402 of the sensor type register 305 as shown in FIG. 4B to be transmitted to the image processor 303 to represent the horizontal size of the frame in which the image sensor 301 is in an activated state.

The vertical size signal “height” is a value stored in the block [b15:b0] of the vertical magnitude register 403 of the sensor type register 305 as shown in FIG. 4C to be transmitted to the image processor 303 to represent the vertical size of the frame in which the image sensor 301 is in the activated state.

The micom 306 stores values corresponding to characteristics of the image sensor 301, which is currently used in the image processing system, in the sensor type register 305 and controls the currently used image sensor 301 using bidirectional communication through the general purpose input/output (GPIO) signal.

FIG. 6 is a structure of the image processor 303 shown in FIG. 3. Referring to FIG. 6, an image signal processing operation performed in the image processor 303 is described in detail hereinafter.

The changed vertical synchronization signal vsync_1, the changed horizontal synchronization signal hsync_1, the changed pixel clock signal pixel_clk_1, the changed pattern signal “pattern,” and the changed pixel data signal pixel_data which are outputted from the sensor interface 203, are transmitted to the image processor 303. The changed vertical synchronization signal vsync_1, the changed horizontal synchronization signal hsync_1, the changed pixel clock signal pixel_clk_1, the pattern signal “pattern,” and the pixel data signal pixel_data are temporarily stored in a line buffer 601 to be used in an interpolation process.

An interpolation unit 602 converts the pixel data having the Bayer pattern received from the line buffer 601 into another data having a RGB pattern. The RGB pattern data is processed by a color processor 603 to be converted into another data, such as YCbCr or YUV signals, which is transmitted to another multiplexer 604 as another pixel data signal pixel_data2.

The multiplexer 604 selects the pixel data signal pixel_data using the ISP mode signal stored in the block b5 of the sensor signal register 401 of FIG. 4A as a control signal. The selected pixel data signal pixel_data is transmitted to a YCbCr/YUV formatter 605. For example, if the ISP mode signal is in the on state, the another pixel data signal pixel_data2 processed by the color processor 603 is selected as an input of the YCbCr/YUV formatter 605, and if the ISP mode signal is in the off state, the pixel data signal pixel_data outputted from the image sensor 301 is selected as the input of the YCbCr/YUV formatter 605.

The YCbCr/YUV formatter 605 generates final output signals of the image processor 303. When the ISP mode signal is in the on state, the YCbCr/YUV formatter 605 receives the changed vertical synchronization, horizontal synchronization, and pixel data signals vsync_1, hsync_1, pixel_clk_1 and the changed pixel data signal pixel_data1 as the input signals, and when the ISP mode signal is in the off state, the YCbCr/YUV formatter 605 receives the signals i_vsync, i_hsync, i_pixel_clk and the pixel data signal pixel_data, which is not processed by an ISP processing operation, as the input signals. In addition, the YCbCr/YUV formatter 605 receives the vertical and horizontal size signals “height” and “width” stored in the sensor type register 305 as the input signals.

The YCbCr/YUV formatter 605 generates a modified pixel data signal pixel_data_3, such as a YcbCr 4:2:2 format signal or a YCbCr 4:2:0 format signal corresponding to CCIR 656 type or CCIR 601 type, or a MPEG or JPEG format signal, and modified vertical and horizontal synchronization signals vsync_2 and hsync_2 of the frame.

As described above, according to the interfacing apparatus and method which are disposed and performed between the image sensor and the image processor, the image processing system of the present invention can adaptively correspond to the image sensor which is currently used in the image processing system and has one of different types of image sensors, according to the manufacturers and product models of the image sensors.

In the interfacing apparatus and method which are disposed and performed between the image sensor and the image processor according to an aspect of the present invention, the image processor can correspond to any one of different types of the image sensors to adaptively process signals outputted from the image sensor, thereby avoiding any additional redesigning process of redesigning the image processor to correspond to the image sensor used in the image processing system, and reducing a manufacturing time and cost of the image processing system.

Although a few preferred embodiments of the present invention have been shown and described, it would be appreciated by those skilled in the art that changes may be made in this embodiment without departing from the principle and sprit of the invention, the scope of which is defined in the claims and their equivalent.

What is claimed:

1. An interface apparatus in an image processing system, comprising:
an image sensor sensing an image;
an image processor processing the sensed image to output image data; and
a sensor interface coupled between the image sensor and the image processor, the sensor interface comprising,
a sensor type register storing information about the image sensor,
a micom storing the information in the sensor type register to control the image sensor, and
a sensor signal processor receiving signals corresponding to the sensed image from the image sensor, converting the signals into modified signals, which the image processor processes to output the image data, according to the information stored in the sensor type register, and transmitting the modified signals to the image processor.

2. The interface apparatus of claim 1, wherein the signals comprise a vertical synchronization signal, a horizontal synchronization signal, a pixel clock signal, and pixel data.

3. The interface apparatus of claim 1, wherein the information stored in the sensor type register comprises:
polarity information of the vertical synchronization signal, the horizontal synchronization signal, and the pixel clock signal;
image signal processing (ISP) mode information and pattern signal information of the image processor;
horizontal size information of the sensed image; and
vertical size information of the sensed image.

4. The interface apparatus of claim 1, wherein the sensor type register comprises:
a sensor signal register;
a horizontal size register; and
a vertical size register.

5. The interface apparatus of claim 4, wherein:
the signals comprises a vertical synchronization signal, a horizontal synchronization signal, and a pixel clock signal;
the information comprises polarity information of the vertical synchronization signal, the horizontal synchronization signal, and the pixel clock signal, image signal processing (ISP) mode information of the image processor, horizontal size information of the sensed image, and vertical size information of the sensed image;
the sensor signal register stores the polarity information and the image signal processing (ISP) mode information;
the horizontal size register stores the horizontal size information; and
the vertical size register storing the vertical size information.

6. The interface apparatus of claim 1, wherein:
the signals comprises a vertical synchronization signal, a horizontal synchronization signal, a pixel clock signal, and a pixel data signal;
the information comprises polarity information of the vertical synchronization signal, the horizontal synchronization signal, and the pixel clock signal, image signal processing (ISP) mode information of the image processor, horizontal size information of the sensed image, and vertical size information of the sensed image; and
the sensor signal processor comprises:
a first multiplexer inverting or non-inverting a polarity of the vertical synchronization signal transmitted from the image sensor according to the polarity information of the vertical synchronization signal stored in the sensor type register,
a second multiplexer outputting an output of the first multiplexer or a low state signal to the image processor according to the image signal processing (ISP) mode information of the image processor,
a third multiplexer inverting or non-inverting a polarity of the horizontal synchronization signal transmitted from the image sensor according to the polarity information of the horizontal synchronization signal stored in the sensor type register,
a fourth multiplexer outputting an output of the third multiplexer or the low state signal to the image processor according to the image signal processing (ISP) mode information of the image processor,
a fifth multiplexer inverting or non-inverting a polarity of the pixel clock signal transmitted from the image sensor according to the polarity information of the pixel clock signal stored in the sensor type register,
a sixth multiplexer outputting an output of the fifth multiplexer or the low state signal to the image processor according to the image signal processing (ISP) mode information of the image processor, and
a seventh multiplexer outputting the pixel data signal or the low state signal to the image processor according to the image signal processing (ISP) mode information of the image processor.

7. The interface apparatus of claim 1, wherein the micom communicates with the image sensor using a general purpose input/ouput signal transmitted between the micom and the image sensor.

8. An interface method of interfacing an image sensor and an image processor in an image processing system, the interface method comprising:
storing information about the image sensor in a sensor type register;
receiving signals from the image sensor;
converting the signals outputted from the image sensor into image data according to the information stored in the sensor type register; and
transmitting the converted image data to the image processor.

9. The interface method of claim 8, wherein the signals comprise a vertical synchronization signal, a horizontal synchronization signal, a pixel clock signal, and pixel data.

10. The interface method of claim 8, wherein the information stored in the sensor type register comprises:
polarity information of the vertical synchronization signal, the horizontal synchronization signal, and the pixel clock signal;
image signal processing (ISP) mode information and pattern signal information of the image processor;
horizontal size information of the sensed image; and
vertical size information of the sensed image.

11. The interface method of claim 8, wherein the sensor type register comprises:
a sensor signal register;
a horizontal size register; and
a vertical size register.

12. The interface method of claim 11, wherein:
the signals comprises a vertical synchronization signal, a horizontal synchronization signal, and a pixel clock signal;
the information comprises polarity information of the vertical synchronization signal, the horizontal synchronization signal, and the pixel clock signal, image signal processing (ISP) mode information and pattern signal information of the image processor, horizontal size information of the sensed image, and vertical size information of the sensed image; and
the storing of the information about an image sensor in a sensor type register comprises,
storing the polarity information and the image signal processing (ISP) mode information in the sensor signal register,
storing the horizontal size information in the horizontal size register, and
storing the vertical size information in the vertical size register.

13. The interface method of claim 8, wherein:
the signals comprises a vertical synchronization signal, a horizontal synchronization signal, and a pixel clock signal;
the information comprises polarity information of the vertical synchronization signal, the horizontal synchronization signal, and the pixel clock signal, image signal processing (ISP) mode information and pattern signal information of the image processor, horizontal size information of the sensed image, and vertical size information of the sensed image; and
the converting of the signals outputted from the image sensor into the image data according to the information stored in the sensor type register comprises,
inverting or non-inverting a polarity of the vertical synchronization signal transmitted from the image sensor according to the polarity information of the vertical synchronization signal stored in the sensor type register,
outputting the inverted or non-inverted vertical synchronization signal or a low state signal to the image processor according to the image signal processing (ISP) mode information of the image processor,
inverting or non-inverting a polarity of the horizontal synchronization signal transmitted from the image sensor according to the polarity information of the horizontal synchronization signal stored in the sensor type register,
outputting the inverted or non-inverted horizontal synchronization signal or the low state signal to the image processor according to the image signal processing (ISP) mode information of the image processor,
inverting or non-inverting a polarity of the pixel clock signal transmitted from the image sensor according to the polarity information of the pixel clock signal stored in the sensor type register,
outputting the inverted or non-inverted pixel clock signal or the low state signal to the image processor according to the image signal processing (ISP) mode information of the image processor, and
outputting the pixel data signal or the low state signal to the image processor according to the image signal processing (ISP) mode information of the image processor.
